(19) United States
(12) Patent Application Publication
(10) Pub. No.: US 2023/0411720 A1
(43) Pub. Date: Dec. 21, 2023

(54) Method of Metal Ion Recovery from Batteries

(71) Applicant: Nanyang Technological University, Singapore (SG)

(72) Inventors: Zhuoran WU, Singapore (SG); Chor Yong TAY, Singapore (SG); Madhavi SRINIVASAN, Singapore (SG); Minh Phuong DO, Singapore (SG)

(21) Appl. No.: 18/035,130

(22) PCT Filed: Nov. 3, 2021
(86) PCT No.: PCT/SG2021/050670

§ 371 Date: May 3, 2023

(30) Foreign Application Priority Data
Nov. 4, 2020 (SG) 10202010984P

(51) Int. Cl. H01M 10/54; C22B 3/00; C22B 26/12; C22B 3/44; C22B 47/00; C22B 7/00

(52) U.S. Cl. CPC H01M 10/54; C22B 23/0446; C22B 26/12; C22B 3/44; C22B 47/0072; C22B 7/008

(57) ABSTRACT

The present disclosure refers to a method of obtaining metal ions from a battery, the method comprising adding a crushed battery to a leaching solution comprising fruit and an ammonium salt, thereby obtaining a leachate comprising metal ions.

### TECHNICAL FIELD

The present disclosure refers to a method of obtaining metal ions from a battery. The present disclosure further refers to a method of obtaining metal salts from a battery. The present disclosure also refers to a method of recovering cathode and/or anode material from lithium-ion batteries.

### BACKGROUND ART

Lithium-ion batteries (LIBs) are currently used in a wide range of electronic products (e.g. smartphones, notebooks, cameras, electronic vehicles, medical devices, etc.) and have become an indispensable part of our life. According to a recent report, the global market value of LIBs is expected to reach USD 139 billion by 2026. As the demand for LIBs continues to grow at a rapid pace, so does the pile of spent LIBs all over the world. Nevertheless, the recycling efficiency of these waste LIBs is far below optimal. Even in developed countries like Australia and US, <5% of the spent LIBs generated are recycled per annum. Most of the spent LIBs often end up in landfills or incinerators, which are not ecologically and economically sustainable.

LIB waste contains valuable resources like cobalt (Co), lithium (Li), manganese (Mn), nickel (Ni), and other metals that could be recovered and reused. In fact, out of the USD 23.51 billion worth of the LIBs that are annually produced, over ⅓ of the value stems from the metallic constituents. Current methods to recycle spent LIBs include pyro-, hydro-, and bio-metallurgy. Although pyrometallurgy is now widely applied in LIBs recycling industry, the large consumption of energy (Temperature >500° C.) and emission of substantial amounts of toxic gases makes it unsustainable and environmentally unfriendly. Biometallurgy uses acid-producing bacteria such as Acidithiobacillus ferrooxidans, Acidithiobacillus thiooxidans, and Aspergillus niger to extract metals from the spent LIBs.

While biometallurgy exerts minimal environmental and health impacts, the inefficiency of the bioleaching process and the susceptibility of the bacteria to the toxic effects of the metals significantly limit its translation from laboratory to industry. Among the rest, hydrometallurgy provides a more direct route of recycling spent LIBs by utilization of water as a solvent. In addition, its high rate of metal extraction, and ease of operation make it a highly attractive approach to treat LIBs waste.

Majority of the existing hydrometallurgical approaches involve acids as solvent and H₂O₂ as reducing agent for extraction of valuable metals from the spent LIBs. While the effectiveness of H₂O₂ as a reductant is undisputed, its long-term use can hardly be deemed sustainable due to its innate corrosiveness and explosiveness. Additionally, the use of corrosive mineral acids in conventional leaching processes are hardly sustainable in the long run. Thus, there is a need to find new methods of recovering metal ions from batteries that overcome or ameliorate the problems.

### SUMMARY

In an aspect of the present disclosure, there is provided a method of obtaining metal ions from a battery, the method comprising adding a crushed battery to a leaching solution comprising fruit and an ammonium salt, thereby obtaining a leachate comprising metal ions.

In another aspect of the present disclosure, there is provided a method of obtaining a metal salt from a battery, the method comprising:
(a) adding a crushed battery to a leaching solution comprising fruit and an ammonium salt, thereby obtaining a leachate comprising metal ions; and
(b) adding a precipitating agent to the leachate to obtain a precipitate comprising the metal salt.

In a further aspect of the present disclosure, there is provided a method of recovering and regenerating a lithium cathode material from a lithium-ion battery (LIB), the method comprising:
(a) adding a crushed LIB to a leaching solution comprising fruit and an ammonium salt, thereby obtaining a leachate comprising metal ions;
(b) adding a precipitating agent to the leachate of step (a), thereby obtaining a precipitate comprising metal salt; and
(c) mixing the precipitate of step (b) with a lithium salt and heating the resulting mixture to obtain a lithium cathode material.

Advantageously, the method of recovering metal ions from batteries disclosed herein is able to extract valuable metals (Co, Mn, Ni, Li) from battery waste with high effectiveness of up to 100% under a near-neutral condition, where pH is in the range of 5-7. This method is thus more sustainable, environmentally friendly and cost-effective than the conventional acid-centric (pH <2) extraction methods.

Further, as the method disclosed herein may be performed in near-neutral conditions, the disclosed method may be a non-corrosive method, unlike conventional acid-leaching methods which cause corrosion of metallic equipment (such as reactors and tubes). Therefore, the present method advantageously avoids the wear and tear of equipment that is typically associated with acid-leaching methods, which greatly reduces the cost of equipment maintenance. The method disclosed herein also demonstrates the applicability of mixed fruit peel waste as a reductant. This advantageously demonstrates that the method may be applied to any generated fruit peel waste without bias, and is a significant demonstration towards its industrial adoption.

The method disclosed herein also provides a greener route of regenerating metal ions from batteries by harnessing the unique properties of ammonium salts, in contrast to the current acid-centric methods. This advantageously avoids the production of substantial amounts of acid-derived environmental pollutants during the leaching process. Furthermore, the method uses cheaply produced ammonium salts in place of expensive and corrosive mineral acids. Most ammonium salts may also be produced as side products from other processes, and this provides an additional strategy of using ammonium salts previously regarded as waste to recover metal ions from batteries.

The method disclosed herein also describes the recovery of metal salts from the addition of precipitating agents to the leachate to basify the solution. Because the original leaching process is performed at near neutral or neutral pH compared to conventional hydrometallurgical processes, the method of the present disclosure advantageously results in significant operational costs savings, estimated to be up to SGD$55 million per annum.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

Unless the context requires otherwise or specifically stated to the contrary, integers, steps, or elements of the invention recited herein as singular integers, steps or elements clearly encompass both singular and plural forms of the recited integers, steps or elements.

As used herein, the term “black mass” refers to shredded and/or crushed components of a battery (such as metal-ion batteries) containing cathode, anode, plastic binder, battery shell and/or other components of a battery.

The word “substantially” does not exclude “completely” e.g. a composition which is “substantially free” from Y may be completely free from Y. Where necessary, the word “substantially” may be omitted from the definition of the invention.

As used herein in the specification and in the claims, the phrase “at least,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1 is a scheme delineating the collection and mechanical processing of fruit peel waste.

FIG. 2a is a graph showing the quantity of antioxidants present in four different batches of fruit peel waste leaching solution.

FIG. 2b is a graph showing the quantity of reducing sugars present in four different batches of fruit peel waste leaching solution.

FIG. 3 is a graph showing the leaching efficiency of various metals from NMC black mass using different batches of fruit peel waste.

FIG. 4 is a series of graphs showing the effect of amount of fruit peel waste on the leaching efficiency of various metals from NMC black mass.

FIG. 5a is a graph showing the effect of NH₄Cl on the leaching efficiency of various metals from NMC black mass in the presence of fruit peel waste.

FIG. 5b is a graph showing the effect of NH₄Cl on the leaching efficiency of various metals from NMC black mass in the absence of fruit peel waste.

FIG. 5c is a UV-VIS spectrum of the lixiviant containing fruit peel waste and NH₄Cl.

FIG. 6 is a series of graphs showing the leaching efficiency of different metals using different ammonium salts in the presence of fruit peel waste.

FIG. 7a is a graph showing the effect of NH₄Cl concentration on the leaching efficiency of various metals from the NMC black mass.

FIG. 7b is a graph showing the effect of leaching temperature on the leaching efficiency of various metals from the NMC black mass.

FIG. 7c is a graph showing the effect of leaching time on the leaching efficiency of various metals from the NMC black mass.

FIG. 7d is a graph showing the effect of slurry density on the leaching efficiency of various metals from the NMC black mass.

FIG. 8a is a scheme showing the processes for the recovery of metals and regeneration of NMC 111 cathode material in the present invention.

FIG. 8b are Scanning Electron Microscopy (SEM) images of the metal oxalate precipitate (nickel, manganese, cobalt) and the recovered NMC 111 cathode material.

FIG. 8c is a X-ray Diffraction (XRD) characterisation of the recovered NMC 111 cathode material, with characteristic peaks of powder diffraction file (PDF) of a reference NMC 111 (PDF #00-062-0431).

FIG. 8d is an Energy-dispersive X-ray spectroscopy (EDX) spectrum of the recovered NMC 111 cathode material, with accompanying insets describing the atomic composition.

FIG. 8e is a graph showing the discharge performance of the recovered NMC 111 cathode material over 50 charge-discharge cycles.

FIG. 8f is a graph showing the cycling performance of the recovered NMC 111 cathode material at different currents (50 mA/g to 400 mA/g).

FIG. 9a is a SEM image of the recovered anode material.

FIG. 9b is a Raman spectrum of the recovered anode material.

FIG. 9c is a graph showing the initial discharge performance of the recovered and commercial graphitic anode over 50 cycles.

FIG. 9d is a graph showing the cycling performance of the recovered and commercial graphitic anode at different currents (50 mA/g to 400 mA/g).

FIG. 10 is a graph showing the initial discharge performance of the recovered NMC 111 batteries over 50 cycles.

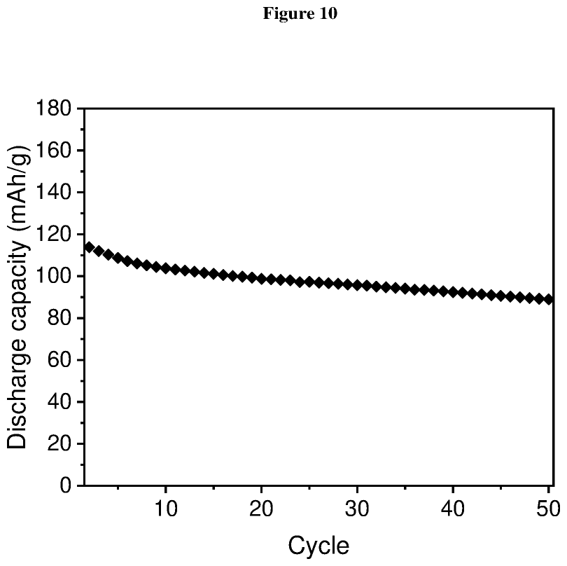

### DETAILED DISCLOSURE OF DRAWINGS

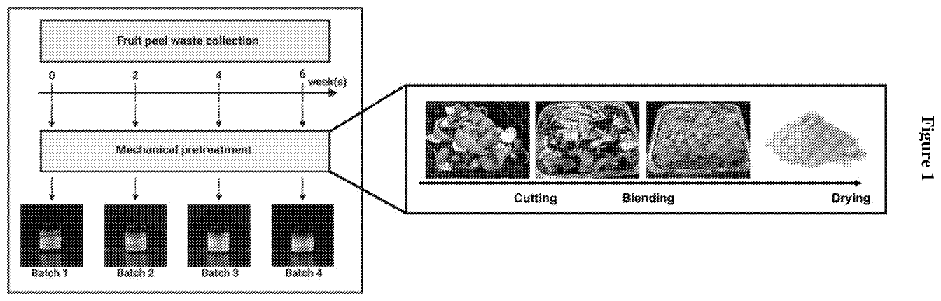

Referring to FIG. 1, four batches of fruit peel waste were collected over the course of six weeks. After mechanical processing such as cutting, blending and freeze-drying, the fine-grain fruit peel waste powder was stored in a capped container and kept dry in a silica gel-containing desiccator. In general, all the fruit peel waste samples collected at different time points appear to be yellowish in colour after the pre-treatments.

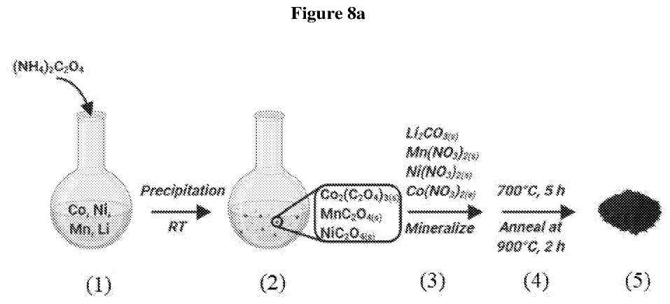

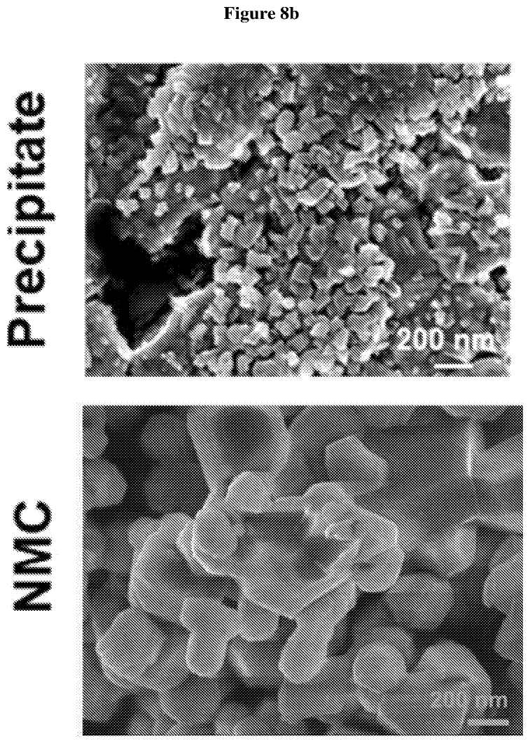

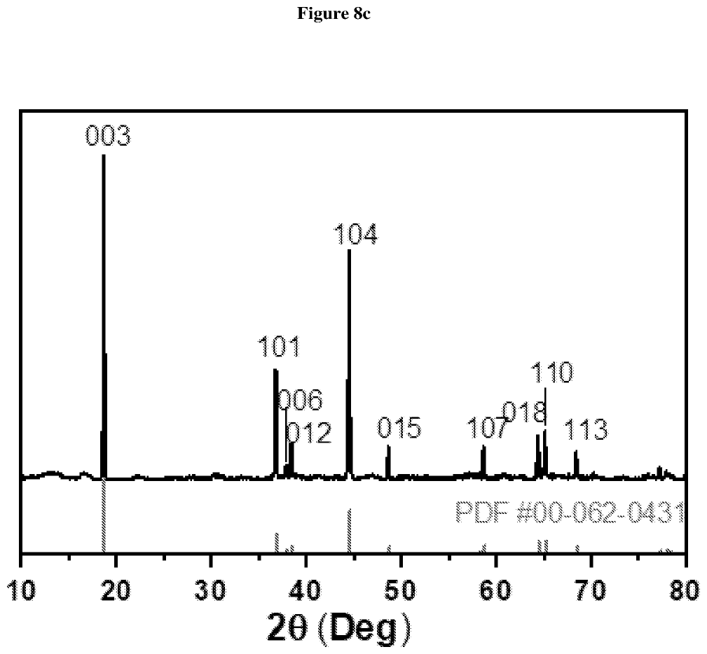

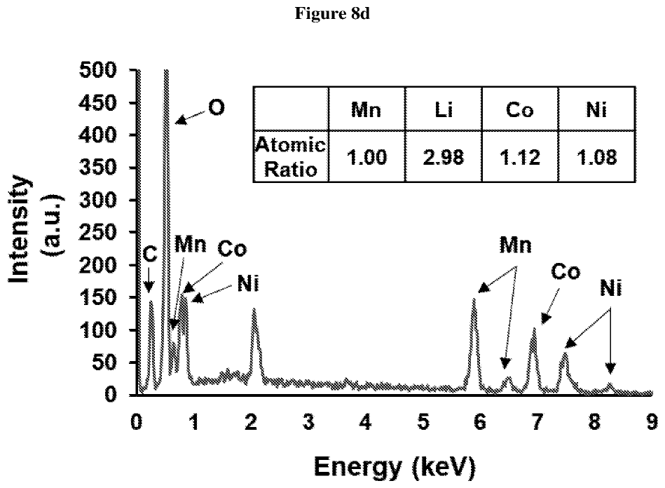

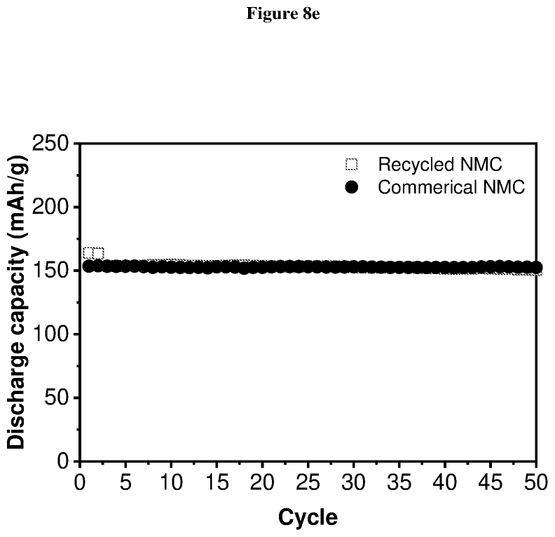

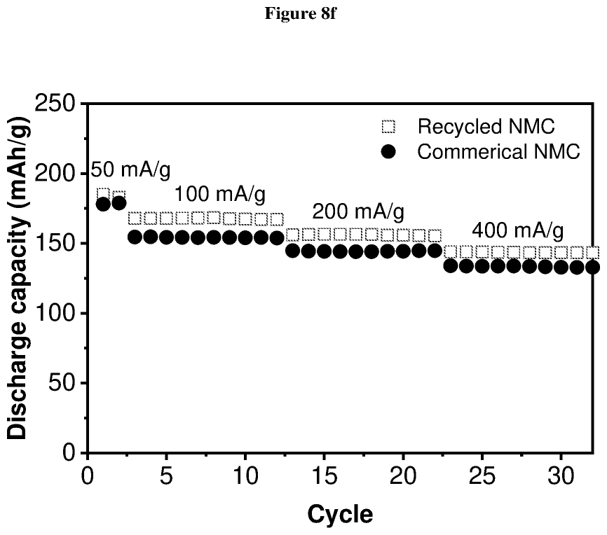

Referring to FIG. 8a, precipitating agents (e.g. (NH₄)C₂O₄) may be added to the leachate/leaching solution (1) comprising metal ions (such as Co, Ni, Mn, Li), to form a leaching solution with precipitates (2) (such as CoC₂O₄(s), MnC₂O₄(s) and NiC₂O₄(0) which is followed by (3) readjustment of the atomic composition (Li:Mn:Ni:Co=3:1:1:1) of the precipitate mixture with addition of Li salts (e.g. Li₂CO₃), and other metal salts (e.g. Mn(NO₃)₂, Ni(NO₃)₂, Co(NO₃)₂). The resultant compound is adjusted to the desired atomic ratio before (4) heat treatment (calcination at 450° C. for 5 hours, and sintering at 700° C.-900° C. for 10 hours), thereby obtaining recycled cathode material as LiNiₓMn_{y}Co_{z}O₂. The recycled cathode material may be used directly for battery assembly.

### Detailed Disclosure of Embodiments

Conventional hydrometallurgical processes require the use of H₂O₂ as reductant, and strong mineral or organic acids. H₂O₂ is highly explosive and corrosive. Furthermore, strong mineral acids are strongly oxidizing and corrosive as well. The neutralisation of the strong acids post-leaching also requires huge amounts of bases. Thus, there is a need to replace either, or both reagents to reduce the operating costs and environmental footprint of such recycling processes.

In this present invention, fruit peels and ammonium salts are used in the recycling of batteries and recovery of metal ions. The fruit peels may be waste fruit peels which are waste products from commercial and industrial processes. The ammonium salts may be purchased, however they may also advantageously be waste products from commercial and industrial processes. Therefore, this unprecedented use may be two-fold: it may replace corrosive and explosive H₂O₂ and mineral acids with inert reagents, increasing the ease of recovery. Secondly, it may find a new use for both fruit peels and ammonium salts which may be waste products and which normally would be discarded. The present invention is thus a significant step towards a zero-waste economy.

The present invention describes a method of obtaining metal ions from a battery, the method comprising adding a crushed battery to a leaching solution comprising fruit and an ammonium salt, thereby obtaining a leachate comprising metal ions.

The battery may be any metal ion battery, such as aluminium ion batteries, lithium ion batteries, potassium ion batteries, magnesium ion batteries, zinc ion batteries or sodium ion batteries. In some embodiments, the battery may be a NMC 111 (LiNiₓMn_{y}Co_{z}O₂, x=y=z=0.3), NMC 622 (LiNiₓMn_{y}Co_{z}O₂, x=0.6, y=z=0.2), or NMC 811 (LiNiₓMn_{y}Co_{z}O₂, x=0.8, y=z=0.1) battery.

The crushed battery may be obtained by shredding, pulverizing, grinding, cutting and/or blending a battery. The battery may be fully discharged prior to shredding, pulverizing, grinding, cutting and/or blending. The battery may be shredded, pulverized, grinded, cut and/or blended without prior dismantling. The crushed battery may be obtained using any instrument and machinery that can break, cut shred, grind, pulverize and/or blend a battery, such as a shaft shredder, pre-chopper, mechanism cutter, or battery cutter. The crushed battery may be sieved to remove any plastic constituents. The resulting sieved crushed battery may be in particulate form. The particulate form may be a black mass particulate.

The crushed battery may be added to the leaching solution. The density of the crushed battery in the leaching solution (w_{battery}/vₛₒₗᵤₜᵢₒₙ) may be about 1 g/L to about 150 g/L, about 5 g/L to about 150 g/L, about 10 g/L to about 150 g/L, about 20 g/L to about 150 g/L, about 25 g/L to about 150 g/L, about 31.25 g/L to about 150 g/L, about 37.5 g/L to about 150 g/L, about 50 g/L to about 150 g/L, about 75 g/L to about 150 g/L, about 100 g/L to about 150 g/L, about 1 g/L to about 100 g/L, about 5 g/L to about 100 g/L, about 10 g/L to about 100 g/L, about 20 g/L to about 100 g/L, about 25 g/L to about 100 g/L, about 31.25 g/L to about 100 g/L, about 37.5 g/L to about 100 g/L, about 50 g/L to about 100 g/L, about 75 g/L to about 100 g/L, about 1 g/L to about 75 g/L, about 5 g/L to about 75 g/L, about 10 g/L to about 75 g/L, about 20 g/L to about 75 g/L, about 25 g/L to about 75 g/L, about 31.25 g/L to about 75 g/L, about 37.5 g/L to about 75 g/L, about 50 g/L to about 75 g/L, about 1 g/L to about 50 g/L, about 5 g/L to about 50 g/L, about 10 g/L to about 50 g/L, about 20 g/L to about 50 g/L, about 25 g/L to about 50 g/L, about 31.25 g/L to about 50 g/L, about 37.5 g/L to about 50 g/L, about 1 g/L to about 37.5 g/L, about 5 g/L to about 37.5 g/L, about 10 g/L to about 37.5 g/L, about 20 g/L to about 37.5 g/L, about 25 g/L to about 37.5 g/L, about 31.25 g/L to about 37.5 g/L, about 1 g/L to about 31.25 g/L, about 5 g/L to about 31.25 g/L, about 10 g/L to about 31.25 g/L, about 20 g/L to about 31.25 g/L, about 25 g/L to about 31.25 g/L, about 1 g/L to about 25 g/L, about 5 g/L to about 25 g/L, about 10 g/L to about 25 g/L, about 20 g/L to about 25 g/L, about 1 g/L to about 20 g/L, about 5 g/L to about 20 g/L, about 10 g/L to about 20 g/L, about 1 g/L to about 10 g/L, about 5 g/L to about 10 g/L, about 1 g/L to about 5 g/L, about 1 g/L, about 5 g/L, about 10 g/L, about 20 g/L, about 25 g/L, about 31.25 g/L, about 37.5 g/L, about 50 g/L, about 75 g/L, about 100 g/L, about 150 g/L, or any range or value therebetween.

The method may be performed at an elevated temperature. The method may be performed at an elevated temperature to increase the leaching efficiency. The method may be performed at a temperature of about 30° C. to about 150° C., about 40° C. to about 150° C., about 50° C. to about 150° C., about 60° C. to about 150° C., about 70° C. to about 150° C., about 80° C. to about 150° C., about 90° C. to about 150° C., about 100° C. to about 150° C., about 110° C. to about 150° C., about 120° C. to about 150° C., about 130° C. to about 150° C., about 140° C. to about 150° C., about 30° C. to about 140° C., about 40° C. to about 140° C., about 50° C. to about 140° C., about 60° C. to about 140° C., about 70° C. to about 140° C., about 80° C. to about 140° C., about 90° C. to about 140° C., about 100° C. to about 140° C., about 110° C. to about 140° C., about 120° C. to about 140° C., about 130° C. to about 140° C., about 30° C. to about 130° C., about 40° C. to about 130° C., about 50° C. to about 130° C., about 60° C. to about 130° C., about 70° C. to about 130° C., about 80° C. to about 130° C., about 90° C. to about 130° C., about 100° C. to about 130° C., about 110° C. to about 130° C., about 120° C. to about 130° C., about 30° C. to about 120° C., about 40° C. to about 120° C., about 50° C. to about 120° C., about 60° C. to about 120° C., about 70° C. to about 120° C., about 80° C. to about 120° C., about 90° C. to about 120° C., about 100° C. to about 120° C., about 110° C. to about 120° C., about 30° C. to about 110° C., about 40° C. to about 110° C., about 50° C. to about 110° C., about 60° C. to about 110° C., about 70° C. to about 110° C., about 80° C. to about 110° C., about 90° C. to about 110° C., about 100° C. to about 110° C., about 30° C. to about 100° C., about 40° C. to about 100° C., about 50° C. to about 100° C., about 60° C. to about 100° C., about 70° C. to about 100° C., about 80° C. to about 100° C., about 90° C. to about 100° C., about 30° C. to about 90° C., about 40° C. to about 90° C., about 50° C. to about 90° C., about 60° C. to about 90° C., about 70° C. to about 90° C., about 80° C. to about 90° C., about 30° C. to about 80° C., about 40° C. to about 80° C., about 50° C. to about 80° C., about 60° C. to about 80° C., about 70° C. to about 80° C., about 30° C. to about 70° C., about 40° C. to about 70° C., about 50° C. to about 70° C., about 60° C. to about 70° C., about 30° C. to about 60° C., about 40° C. to about 60° C., about 50° C. to about 60° C., about 30° C. to about 50° C., about 40° C. to about 50° C., about 30° C. to about 40° C., about 30° C., about 40° C., about 50° C., about 60° C., about 70° C., about 80° C., about 90° C., about 100° C., about 110° C., about 120° C., about 130° C., about 140° C., about 150° C., or any range or value therebetween.

Any ammonium salt may be used in the leaching method. The ammonium salt may be ammonium chloride, ammonium fluoride, ammonium iodide, ammonium bromide, ammonium vanadate, ammonium dihydrogen phosphate, ammonium hydrogen phosphate, ammonium phosphate, ammonium sulphate, ammonium hydrogen sulphate, ammonium persulfate, ammonium acetate, ammonium oxalate, ammonium carbonate, ammonium bicarbonate, ammonium thiocyanate, ammonium formate, or ammonium propionate. The ammonium salt may be ammonium sulfate, ammonium chloride, ammonium acetate or any mixtures and combinations thereof. The ammonium salt may be ammonium chloride. This demonstrates the high versatility of the leaching method.

Any anion may be used for the ammonium salt. The anion may merely be present as a counterion to the leached metal cations. The resultant salt formed from the metal cations and the anion from the originally added ammonium salt may be significantly soluble in solution, may be moderately soluble in solution, may be sparingly soluble in solution, may be almost insoluble in solution, or may change solubility in reaction to changes in solution temperature. Hence, the method disclosed herein may be additionally modified to advantageously promote the precipitation or solution of certain metal salts at various temperatures, so that only selected metal salts may be favourably precipitated out and subsequently separated.

The ammonium salt may have a two-fold effect, firstly being that it is a proton donor during the leaching process. The leaching may be performed at a range of about pH 1 to about pH 9, about pH 1.42 to about pH 9, about pH 1.5 to about pH 9, about pH 2 to about pH 9, about pH 2.5 to about pH 9, about pH 3 to about pH 9, about pH 3.5 to about pH 9, about pH 4 to about pH 9, about pH 4.5 to about pH 9, about pH 5 to about pH 9, about pH 5.5 to about pH 9, about pH 6 to about pH 9, about pH 6.5 to about pH 9, about pH 7 to about pH 9, about pH 7.5 to about pH 9, about pH 8 to about pH 9, about pH 8.5 to about pH 9, about pH 1 to about pH 8.5, about pH 1 to about pH 8, about pH 1 to about pH 7.5, about pH 1 to about pH 7, about pH 1 to about pH 6.5, about pH 1 to about pH 6, about pH 1 to about pH 5.5, about pH 1 to about pH 5, about pH 1 to about pH 4.5, about pH 1 to about pH 4, about pH 1 to about pH 3.5, about pH 1 to about pH 3, about pH 1 to about pH 2.5, about pH 1 to about pH 2, about pH 1 to about pH 1.5, or about pH 1, pH 1.42, pH 1.5, pH 2, pH 2.5, pH 3, pH 3.5, pH 4, pH 4.5, pH 5, pH 5.5, pH 6, pH 6.5, pH 7, pH 7.5, pH 8, pH 8.5, pH 9, or any value or range therebetween. In an embodiment, the leaching may be performed at near neutral pH, from about pH 5 to about pH 8.5, from about pH 5.5 to about pH 8.5, from about pH 6 to about pH 8.5, from about pH 6.25 to about pH 8.5, from about pH 6.5 to about pH 8.5, from about pH 6.7 to about pH 8.5, from about pH 6.85 to about pH 8.5, from about pH 7 to about pH 8.5, from about pH 7.5 to about pH 8, from about pH 7.8 to about pH 8.5, from about pH 8 to about pH 8.5, from about pH 5 to about pH 8, from about pH 5.5 to about pH 8, from about pH 6 to about pH 8, from about pH 6.25 to about pH 8, from about pH 6.5 to about pH 8, from about pH 6.7 to about pH 8, from about pH 6.85 to about pH 8, from about pH 7 to about pH 8, from about pH 7.5 to about pH 8, from about pH 7.8 to about pH 8, from about pH 5 to about pH 7.8, from about pH 5.5 to about pH 7.8, from about pH 6 to about pH 7.8, from about pH 6.25 to about pH 7.8, from about pH 6.5 to about pH 7.8, from about pH 6.7 to about pH 7.8, from about pH 6.85 to about pH 7.8, from about pH 7 to about pH 7.8, from about pH 7.5 to about pH 7.8, from about pH 5 to about pH 7.5, from about pH 5.5 to about pH 7.5, from about pH 6 to about pH 7.5, from about pH 6.25 to about pH 7.5, from about pH 6.5 to about pH 7.5, from about pH 6.7 to about pH 7.5, from about pH 6.85 to about pH 7.5, from about pH 7 to about pH 7.5, from about pH 5 to about pH 7, from about pH 5.5 to about pH 7, from about pH 6 to about pH 7, from about pH 6.25 to about pH 7, from about pH 6.5 to about pH 7, from about pH 6.7 to about pH 7, from about pH 6.85 to about pH 7, from about pH 5 to about pH 6.85, from about pH 5.5 to about pH 6.85, from about pH 6 to about pH 6.85, from about pH 6.25 to about pH 6.85, from about pH 6.5 to about pH 6.85, from about pH 6.7 to about pH 6.85, from about pH 5 to about pH 6.7, from about pH 5.5 to about pH 6.7, from about pH 6 to about pH 6.7, from about pH 6.25 to about pH 6.7, from about pH 6.5 to about pH 6.7, from about pH 5 to about pH 6.5, from about pH 5.5 to about pH 6.5, from about pH 6 to about pH 6.5, from about pH 6.25 to about pH 6.5, from about pH 5 to about pH 6.25, from about pH 5.5 to about pH 6.25, from about pH 6 to about pH 6.25, from about pH 5 to about pH 6, from about pH 5.5 to about pH 6, from about pH 5 to about pH 5.5, about pH 5, about pH 5.5, about pH 6, about pH 6.25, about pH 6.5, about pH 6.7, about pH 6.85, about pH 7, about pH 7.5, about pH 7.8, about pH 8, about pH 8.5, or any range or value therebetween.

The ammonium salt may be dissolved in water, thereby forming NH₃ and H₃O⁺, and wherein the NH₃ forms coordination complexes with metal ions. The complexation between NH₃ and metal ions may increase the formation rate of H₂O⁺.

The ammonia molecule, liberated from the reaction of NH₄⁺ and H₂O, may form coordination complexes with the metal ions, thus increasing the solubility of the leached metal ions and advantageously increasing the leaching efficiency of the method. Correspondingly, the metal ions may be further isolated as metal salts comprising metal-ammonia complexes.

In some embodiments of the present invention, the pH of the solution may increase after the leaching process. This may be attributed to the consumption of NH₄⁺ ions. The final pH of the solution may be from about pH 1.5 to about pH 9.5, about pH 1.55 to about pH 9, about pH 2 to about pH 9.5, about pH 2.5 to about pH 9.5, about pH 3 to about pH 9.5, about pH 3.5 to about pH 9.5, about pH 4 to about pH 9.5, about pH 4.5 to about pH 9.5, about pH 5 to about pH 9.5, about pH 5.5 to about pH 9.5, about pH 6 to about pH 9.5, about pH 6.5 to about pH 9.5, about pH 7 to about pH 9.5, about pH 7.5 to about pH 9.5, about pH 8 to about pH 9.5, about pH 8.5 to about pH 9.5, about pH 9 to about pH 9.5, about pH 1.5 to about pH 9, about pH 1.5 to about pH 8.5, about pH 1.5 to about pH 8, about pH 1.5 to about pH 7.5, about pH 1.5 to about pH 7, about pH 1.5 to about pH 6.5, about pH 1.5 to about pH 6, about pH 1.5 to about pH 5.5, about pH 1.5 to about pH 5, about pH 1.5 to about pH 4.5, about pH 1.5 to about pH 3, about pH 1.5 to about pH 2.5, about pH 1.5 to about pH 2, or about pH 1.5, about pH 1.55, about pH 2, about pH 2.5, about pH 3, about pH 3.5, about pH 4, about pH 4.5, about pH 5, about pH 5.5, about pH 6, about pH 6.5, about pH 7, about pH 7.5, about pH 8, about pH 8.5, about pH 9, or any value or range therebetween. In an embodiment, the final pH of the solution may be from about pH 7 to about pH 9, from about pH 7.05 to about pH 9, from about pH 7.3 to about pH 9, from about pH 7.4 to about pH 9, from about pH 7.5 to about pH 9, from about pH 7.6 to about pH 9, from about pH 8 to about pH 9, from about pH 8.5 to about pH 9, from about pH 8.9 to about pH 9, from about pH 7 to about pH 8.9, from about pH 7.05 to about pH 8.9, from about pH 7.3 to about pH 8.9, from about pH 7.4 to about pH 8.9, from about pH 7.5 to about pH 8.9, from about pH 7.6 to about pH 8.9, from about pH 8 to about pH 8.9, from about pH 8.5 to about pH 8.9, from about pH 7 to about pH 8.5, from about pH 7.05 to about pH 8.5, from about pH 7.3 to about pH 8.5, from about pH 7.4 to about pH 8.5, from about pH 7.5 to about pH 8.5, from about pH 7.6 to about pH 8.5, from about pH 8 to about pH 8.5, from about pH 7 to about pH 8, from about pH 7.05 to about pH 8, from about pH 7.3 to about pH 8, from about pH 7.4 to about pH 8, from about pH 7.5 to about pH 8, from about pH 7.6 to about pH 8, from about pH 7 to about pH 7.6, from about pH 7.05 to about pH 7.6, from about pH 7.3 to about pH 7.6, from about pH 7.4 to about pH 7.6, from about pH 7.5 to about pH 7.6, from about pH 7 to about pH 7.5, from about pH 7.05 to about pH 7.5, from about pH 7.3 to about pH 7.5, from about pH 7.4 to about pH 7.5, from about pH 7 to about pH 7.4, from about pH 7.05 to about pH 7.4, from about pH 7.3 to about pH 7.4, from about pH 7 to about pH 7.3, from about pH 7.05 to about pH 7.3, from about pH 7 to about pH 7.05, about pH 7, about pH 7.05, about pH 7.3, about pH 7.4, about pH 7.5, about pH 7.6, about pH 8, about pH 8.5, about pH 8.9, about pH 9, or any range or value therebetween.

The ammonium salt may be added in a certain weight ratio to the water used. The weight ratio of the ammonium salt to water may be about 1:200 to 1:1, about 1:100 to 1:1, about 1:50 to 1:1, about 1:25 to 1:1, about 1:10 to 1:1, about 1:8.33 to 1:1, about 1:5 to 1:1, about 1:4 to 1:1, about 1:3 to 1:1, about 1:2 to 1:1, about 1:200 to 1:2, about 1:100 to 1:2, about 1:50 to 1:2, about 1:25 to 1:2, about 1:10 to 1:2, about 1:8.33 to 1:2, about 1:5 to 1:2, about 1:4 to 1:2, about 1:3 to 1:2, about 1:200 to 1:3, about 1:100 to 1:3, about 1:50 to 1:3, about 1:25 to 1:3, about 1:10 to 1:3, about 1:8.33 to 1:3, about 1:5 to 1:3, about 1:4 to 1:3, about 1:200 to 1:4, about 1:100 to 1:4, about 1:50 to 1:4, about 1:25 to 1:4, about 1:10 to 1:4, about 1:8.33 to 1:4, about 1:5 to 1:4, about 1:200 to 1:5, about 1:100 to 1:5, about 1:50 to 1:5, about 1:25 to 1:5, about 1:10 to 1:5, about 1:8.33 to 1:5, about 1:200 to 1:8.33, about 1:100 to 1:8.33, about 1:50 to 1:8.33, about 1:25 to 1:8.33, about 1:10 to 1:8.33, about 1:200 to 1:10, about 1:100 to 1:10, about 1:50 to 1:10, about 1:25 to 1:10, about 1:200 to 1:25, about 1:100 to 1:25, about 1:50 to 1:25, about 1:200 to 1:50, about 1:100 to 1:50, about 1:200 to 1:100, about 1:200, about 1:100, about 1:50, about 1:25, about 1:10, about 1:8.33, about 1:5, about 1:4, about 1:3, about 1:2, about 1:1 or any range or value therebetween.

The fruit used may be mixed fruit, instead of only a single fruit. Mixed fruit may be used in the leaching method without affecting the leaching efficiency. The fruit may be orange, pear, lemon, apple, banana, lime, pineapple, grapefruit, blackberry, raspberry, cranberry, tamarind, grape, mango, papaya, honeydew, pomelo, watermelon, kiwi, plum, peach, lime, sweet potato, avocado, cucumber, dragon fruit, guava, jackfruit, durian, or mixtures thereof.

The fruit may be the whole of the fruit, or its peel, flesh, seeds, or any combination and parts thereof. In an embodiment, the fruit may be primarily fruit peels. The fruit peels may be peels that have been discarded after the flesh of the fruit has been consumed, and thus are referred to as “waste fruit peels” or “waste peels”, or simply “waste”.

The fruit may be untreated, or in powder or blended form. The fruit may be untreated, or treated to improve its leaching properties. The fruit may be mechanically treated, for example the fruit may be cut, chopped, shredded, grinded, grated and/or blended to obtain treated fruit. In other embodiments, the fruit may be dried substantially or completely using the sun, heat, high temperatures, driers, ovens, freeze driers or dehydrators. In other embodiments, the fruit may be mechanically treated first, then dried. In some other embodiments, the fruit may be dried first then mechanically treated. In further embodiments, the fruit may be simultaneously dried and mechanically treated.

The mechanical treatment and/or drying of the fruit leaves a powder as a product ready for use in the recovery of metal ions. In some embodiments, the powder is referred to as “waste fruit peel powder”. The average particle size of the waste fruit peel powder may be in the range of about 50 μm to about 500 μm, about 50 μm to about 450 μm, about 50 μm to about 400 μm, about 50 μm to about 350 μm, about 50 μm to about 300 μm, about 50 μm to about 250 μm, about 50 μm to about 200 μm, about 50 μm to about 150 μm, about 50 μm to about 100 μm, about 100 μm to about 500 μm, about 100 μm to about 450 μm, about 100 μm to about 400 μm, about 100 μm to about 350 μm, about 100 μm to about 300 μm, about 100 μm to about 250 μm, about 100 μm to about 200 μm, about 100 μm to about 150 μm, about 150 μm to about 500 μm, about 200 μm to about 500 μm, about 250 μm to about 500 μm, about 300 μm to about 500 μm, about 350 μm to about 500 μm, about 400 μm to about 500 μm, about 450 μm to about 500 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, about 410 μm, about 420 μm, about 430 μm, about 440 μm, about 450 μm, about 460 μm, about 470 μm, about 480 μm, about 490 μm, about 500 μm, or any value or range therebetween.

The concentration of the fruit in the leaching solution may be about 0.5 mg/ml to about 300 mg/ml, about 1 mg/ml to about 300 mg/ml, about 5 mg/ml to about 300 mg/ml, about 10 mg/ml to about 300 mg/ml, about 20 mg/ml to about 300 mg/ml, about 40 mg/ml to about 300 mg/ml, about 60 mg/ml to about 300 mg/ml, about 80 mg/ml to about 300 mg/ml, about 100 mg/ml to about 300 mg/ml, about 150 mg/ml to about 300 mg/ml, about 200 mg/ml to about 300 mg/ml, about 0.5 mg/ml to about 200 mg/ml, about 1 mg/ml to about 200 mg/ml, about 5 mg/ml to about 200 mg/ml, about 10 mg/ml to about 200 mg/ml, about 20 mg/ml to about 200 mg/ml, about 40 mg/ml to about 200 mg/ml, about 60 mg/ml to about 200 mg/ml, about 80 mg/ml to about 200 mg/ml, about 100 mg/ml to about 200 mg/ml, about 150 mg/ml to about 200 mg/ml, about 0.5 mg/ml to about 150 mg/ml, about 1 mg/ml to about 150 mg/ml, about 5 mg/ml to about 150 mg/ml, about 10 mg/ml to about 150 mg/ml, about 20 mg/ml to about 150 mg/ml, about 40 mg/ml to about 150 mg/ml, about 60 mg/ml to about 150 mg/ml, about 80 mg/ml to about 150 mg/ml, about 100 mg/ml to about 150 mg/ml, about 0.5 mg/ml to about 100 mg/ml, about 1 mg/ml to about 100 mg/ml, about 5 mg/ml to about 100 mg/ml, about 10 mg/ml to about 100 mg/ml, about 20 mg/ml to about 100 mg/ml, about 40 mg/ml to about 100 mg/ml, about 60 mg/ml to about 100 mg/ml, about 80 mg/ml to about 100 mg/ml, about 0.5 mg/ml to about 80 mg/ml, about 1 mg/ml to about 80 mg/ml, about 5 mg/ml to about 80 mg/ml, about 10 mg/ml to about 80 mg/ml, about 20 mg/ml to about 80 mg/ml, about 40 mg/ml to about 80 mg/ml, about 60 mg/ml to about 80 mg/ml, about 0.5 mg/ml to about 60 mg/ml, about 1 mg/ml to about 60 mg/ml, about 5 mg/ml to about 60 mg/ml, about 10 mg/ml to about 60 mg/ml, about 20 mg/ml to about 60 mg/ml, about 40 mg/ml to about 60 mg/ml, about 0.5 mg/ml to about 40 mg/ml, about 1 mg/ml to about 40 mg/ml, about 5 mg/ml to about 40 mg/ml, about 10 mg/ml to about 40 mg/ml, about 20 mg/ml to about 40 mg/ml, about 0.5 mg/ml to about 20 mg/ml, about 1 mg/ml to about 20 mg/ml, about 5 mg/ml to about 20 mg/ml, about 10 mg/ml to about 20 mg/ml, about 0.5 mg/ml to about 10 mg/ml, about 1 mg/ml to about 10 mg/ml, about 5 mg/ml to about 10 mg/ml, about 0.5 mg/ml to about 5 mg/ml, about 1 mg/ml to about 5 mg/ml, about 0.5 mg/ml to about 1 mg/ml, about 0.5 mg/ml, about 1 mg/ml, about 5 mg/ml, about 10 mg/ml, about 20 mg/ml, about 40 mg/ml, about 60 mg/ml, about 80 mg/ml, about 100 mg/ml, about 150 mg/ml, about 200 mg/ml, about 300 mg/ml, or any range or value therebetween.

The present invention also demonstrates that it is capable of recovering metal ions from batteries. The metal ions recovered may be lithium, nickel, manganese, cobalt, zinc, copper, iron, silver, vanadium, titanium, chromium, aluminium or any combinations thereof. In further embodiments, the metal recovered may comprise lithium, nickel, manganese, cobalt and aluminium.

In some embodiments, carbonate salt and traces of nitrogen may be detected from the recovered material. The amount of nitrogen and carbonate salt detected may be about 0.1%, about 0.2%, about 0.3%, about 0.4%, about 0.5%, about 0.6%, about 0.7%, about 0.8%, about 0.9%, about 1.0%, about 0.1% to about 1.0%, about 0.2% to about 1.0%, about 0.3% to about 1.0%, about 0.4% to about 1.0%, about 0.5% to about 1.0%, about 0.6% to about 1.0%, about 0.7% to about 1.0%, about 0.8% to about 1.0%, about 0.9% to about 1.0%, about 0.1% to about 0.9%, about 0.2% to about 0.9%, about 0.3% to about 0.9%, about 0.4% to about 0.9%, about 0.5% to about 0.9%, about 0.6% to about 0.9%, about 0.7% to about 0.9%, about 0.8% to about 0.9%, about 0.1% to about 0.8%, about 0.2% to about 0.8%, about 0.3% to about 0.8%, about 0.4% to about 0.8%, about 0.5% to about 0.8%, about 0.6% to about 0.8%, about 0.7% to about 0.8%, about 0.1% to about 0.7%, about 0.2% to about 0.7%, about 0.3% to about 0.7%, about 0.4% to about 0.7%, about 0.5% to about 0.7%, about 0.6% to about 0.7%, about 0.1% to about 0.6%, about 0.2% to about 0.6%, about 0.3% to about 0.6%, about 0.4% to about 0.6%, about 0.5% to about 0.6%, about 0.1% to about 0.5%, about 0.2% to about 0.5%, about 0.3% to about 0.5%, about 0.4% to about 0.5%, about 0.1% to about 0.4%, about 0.2% to about 0.4%, about 0.3% to about 0.4%, about 0.1% to about 0.3%, about 0.2% to about 0.3%, about 0.1% to about 0.2%, or any value or range therebetween.

The method of recovering metal ions from a battery may result in a leachate comprising soluble metal ions in some embodiments. In other embodiments, the method may result in a leachate comprising some metal ions in the solution, and some metals ions that have precipitated out as metal salts. In further embodiments, the method may result in a leachate where most of the metal ions have precipitated out as metal salts and some metal ions remain in solution. In some other embodiments, the method may result in a leachate where substantially all the metal ions have precipitated out as metal salts.

The present invention also relates to a method of obtaining a metal salt from a battery, the method comprising adding a crushed battery to a leaching solution comprising fruit and an ammonium salt, thereby obtaining a leachate comprising metal ions and a precipitate comprising at least one metal salt.

The present invention also relates to a method of obtaining a metal salt from a battery, the method comprising:
(a) adding a crushed battery to a leaching solution comprising fruit and an ammonium salt, thereby obtaining a leachate comprising metal ions; and
(b) adding a precipitating agent to the leachate to obtain a precipitate comprising the metal salt.

The present invention further relates to a method of obtaining a metal salt from a battery, the method comprising:
(a) adding a crushed battery to a leaching solution comprising fruit and an ammonium salt, thereby obtaining a leachate comprising metal ions;
(b) adding a precipitating agent to the leachate to obtain a precipitate comprising the metal salt
(c) filtering the precipitate from the leachate to form a second leachate; and
(d) repeating step (a) using the second leachate as the leaching solution.

The present invention also relates to a method of obtaining more than one metal salt from a battery, the method comprising:
(a) adding a crushed battery to a leaching solution comprising fruit and an ammonium salt, thereby obtaining a leachate comprising metal ions;
(b) adding a first precipitating agent to the leachate to obtain a first precipitate comprising a first metal salt;
(c) filtering the precipitate from the leachate to form a second leachate; and
(d) adding a second precipitating agent to the second leachate to obtain a second precipitate comprising a second metal salt.

The present invention also relates to a further method of obtaining more than one metal salt from a battery, the method comprising:
(a) adding a crushed battery to a leaching solution comprising fruit and an ammonium salt, thereby obtaining a leachate comprising metal ions;
(b) adding a first precipitating agent to the leachate to obtain a first precipitate comprising a first metal salt;
(c) filtering the precipitate from the leachate to form a second leachate; and
(d) adding a second precipitating agent to the second leachate to obtain a second precipitate comprising a second metal salt,
wherein any of the preceding steps may be accompanied by a heating or cooling step.

In some embodiments, the precipitating agent may be salts selected from the group of hydroxide, carbonate, bicarbonate, oxalate, sulfite, bisulfite, phosphate, pyrophosphate, iodate, and persulfate. The cations may be hydrogen, ammonium, sodium, or potassium cations.

The precipitating agent may be selected from the group consisting of sodium hydroxide, sodium chloride, sodium bisulfate, monosodium phosphate, disodium phosphate, trisodium phosphate, sodium carbonate, sodium bicarbonate, sodium sulfite, sodium bisulfite, calcium hydroxide, sodium oxalate, ammonium oxalate, ammonium hydroxide, ammonium bisulfate, ammonium phosphate, ammonium carbonate, ammonium bicarbonate, ammonium sulfite, oxalic acid, phosphoric acid, carbonic acid, magnesium hydroxide and any mixture thereof.

The precipitate produced from the method may comprise cobalt salt, manganese salt, lithium, and/or nickel salt. In other embodiments, the precipitate produced from the method may comprise cobalt salt, manganese salt and/or nickel salt.

The method disclosed in the present invention is capable of obtaining metal salts from a battery. The metal salt may be further modified, reacted, or treated for other applications.

Thus, the present invention also discloses a method of recovering and regenerating a cathode material from a battery, the method comprising:
(a) adding a crushed battery to a leaching solution comprising fruit and an ammonium salt, thereby obtaining a leachate comprising metal ions;
(b) adding a precipitating agent to the leachate of step (a), thereby obtaining a precipitate comprising metal salt; and
(c) mixing the precipitate of step (b) with a salt and heating the resulting mixture to obtain a cathode material.

The cathode material may be a lithium, cobalt, vanadium, iron, manganese, nickel, aluminium and/or titanate cathode material.

The present invention also discloses a method of recovering and regenerating a lithium cathode material from a lithium-ion battery (LIB), the method comprising:
(a) adding a crushed LIB to a leaching solution comprising fruit and an ammonium salt, thereby obtaining a leachate comprising metal ions;
(b) adding a precipitating agent to the leachate of step (a), thereby obtaining a precipitate comprising metal salt; and
(c) mixing the precipitate of step (b) with a lithium salt and heating the resulting mixture to obtain a lithium cathode material.

The present invention also discloses a method of recovering and regenerating a lithium cathode material from a lithium-ion battery (LIB), the method comprising:
(a) adding a crushed battery to a leaching solution comprising fruit and an ammonium salt, thereby obtaining a first leachate comprising metal ions;
(b) adding a first precipitating agent to the first leachate to obtain a first precipitate comprising a first metal salt;
(c) filtering the first precipitate from the first leachate to form a second leachate;
(d) adding a second precipitating agent to the second leachate to obtain a second precipitate comprising a second metal salt; and
(e) mixing the first precipitate of step (b) and the second precipitate of step (d) and heating the resulting mixture to obtain a lithium cathode material.

In an embodiment, step (e) may further comprise adding a lithium salt to the first precipitate of step (b) and the second precipitate of step (d) prior to heating.

The lithium cathode material may be selected from the group consisting of lithium cobalt oxide (LCO), lithium manganese oxide (LMO), lithium nickel manganese cobalt oxide (LNMCO), lithium titanium oxide (LTO), lithium iron phosphate (LFP), lithium nickel oxide (LiNiO₂), lithium manganese dioxide (LiMnO₂), lithium manganese nickel oxide (LiNi_{0.5}Mn_{1.5}O₄) (Spinel, LMNO), lithium manganese phosphate (LiMnPO₄), lithium nickel phosphate (LiNiPO₄), lithium cobalt phosphate (LiCoPO₄), lithium nickel cobalt aluminium oxide (LiNi_{0.8}Co_{0.15}Al_{0.05}O₂), and any mixture thereof.

In some embodiments, the lithium salt may be selected from the group consisting of lithium hydroxide, lithium carbonate, lithium nitrate, lithium acetate, lithium oxalate, lithium chloride, lithium phosphate, lithium sulfate, lithium borate, lithium oxide, and any mixture thereof.

The present invention similarly discloses a method of recovering and regenerating a graphitic anode material from a battery, the method comprising:
(a) adding a crushed battery to a leaching solution comprising fruit and an ammonium salt, thereby obtaining a leachate comprising metal ions and solid graphitic anode material;
(b) filtering the leachate of step (a), thereby obtaining a mixture containing crude solid graphite and carbonaceous materials; and
(c) heating the resulting mixture to obtain the graphitic anode material.

The graphite anode may be recovered directly from the leaching residue. After the leaching reaction, the residue may be washed with water and dried in oven at about 80° C. to about 100° C., ball-milled and undergo carbonization under N2 atmosphere at about 700° C. to about 900° C.

The residue may be dried at about 60° C. to about 100° C., about 65° C. to about 100° C., about 70° C. to about 100° C., about. 75° C. to about 100° C., about 80° C. to about 100° C., about 85° C. to about 100° C., about 90° C. to about 100° C., about 95° C. to about 100° C., about 60° C. to about 95° C., about 60° C. to about 90° C., about 60° C. to about 85° C., about 60° C. to about 80° C., about 60° C. to about 75° C., about 60° C. to about 70° C., about 60° C. to about 65° C., or about 60° C., about 65° C., about 70° C., about 75° C., about 80° C., about 85° C., about 90° C., about 95° C., about 100° C., or any value or range therebetween.

The carbonization temperature may be about 700° C. to about 900° C., about 750° C. to about 900° C., about 800° C. to about 900° C., about 850° C. to about 900° C., about 700° C. to about 850° C., about 700° C. to about 800° C., about 700° C. to about 750° C., or about 700° C., about 750° C., about 800° C., about 850° C., about 900° C., or any value or range therebetween.

### EXAMPLES

Non-limiting examples of the invention and comparative examples will be further described in greater detail by reference to specific examples, which should not be construed as in any way limiting the scope of the invention.

### Materials

Spent LIBs batteries were collected from the National Technological University (NTU), Singapore campus. Ammonium salts were obtained from Sigma-Aldrich and Alfa Aesar. Graphite was obtained from Alfa Aesar. Li₂CO₃, Ni(NO₃)₂, Mn(NO₃)₂ and Co(NO₃)₂ were obtained from Sigma-Aldrich. LiPF₆ EC/DMC was obtained from Sigma-Aldrich. NMC cathodes were obtained from MTI Corporation.

### Example 1

### Processing of Mixed Fruit Peel Waste

FIG. 1 illustrates the collection process and mechanical treatments of the fruit peel waste. In total four batches of fruit peel waste were collected over the course of 6 weeks. After each round of collection, the waste fruit peels were cut into pieces (about 2 to 3 cm in length and about 2 to 4 mm in thickness). The samples were then blended and immediately freeze-dried over 72 hours to ensure complete removal of moisture. The dried samples were then pulverized and sieved with a #60 mesh (pore size of 250 μm) to produce the fruit peel waste powder as used in the present invention. After mechanical processing such as cutting, blending and freeze-drying, the fine-grained fruit peel waste powder was stored in a capped-container and kept dry in a silica gel containing desiccator. In general, all the fruit peel waste samples collected at different time points appear to be yellowish in colour after the pre-treatments.

### Example 2

### Processing of Spent LIBs

Owing to the popularity of Mn, Ni, Co metal in LIB applications, NMC (LiMnₓNi_{y}Co_{y}O₂) batteries were chosen as representative spent LIBs for this study. Spent NMC LIBs were fully discharged by submerging them in 20 wt % NaCl solution overnight. The batteries were confirmed to be completely discharged using a battery tester (BT 3554). After which, the fully discharged batteries were shredded without prior dismantling using a custom-made shredder designed for battery processing (up to 10 kg/h) under inert gas conditions at room temperature. The samples were then kept under exhaust section overnight before being air-dried in a fume cupboard. Finally, the dried materials were ground using a commercial food processor (JDC 3 L, 300 W) for approximately 1 min and sieved using a mesh of pore size 60 μm to remove the plastic constituents. The resultant fine powder was, hence forth referred to as black mass, was stored in a desiccator for subsequent studies.

### Example 3

### Characterisation of Fruit Peel Waste Powder

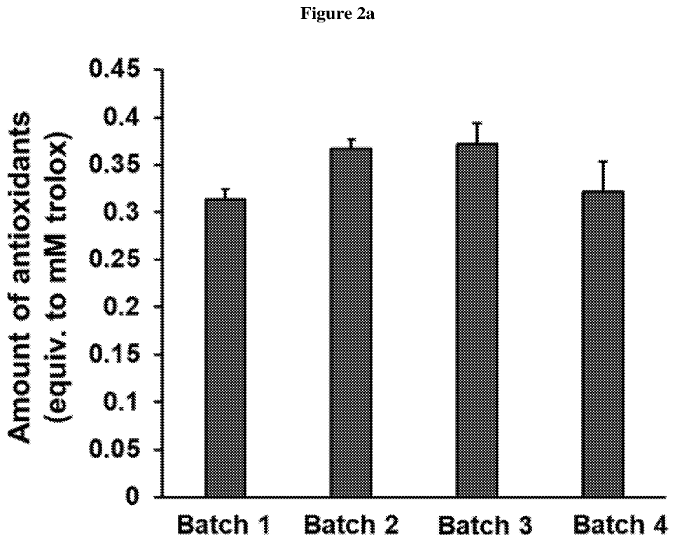

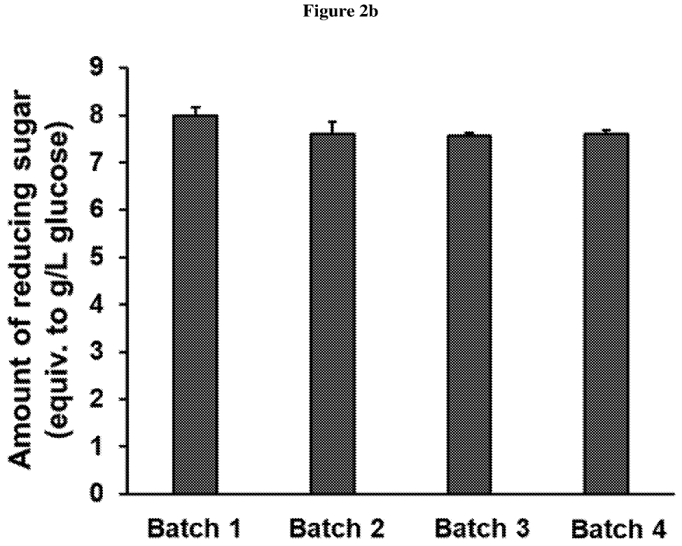

The antioxidants and reducing agent present in the fruit peel waste powder were quantified by 2,2′-Azino-bis(3-Ethylbenzothiazoline-6-Sulfonic Acid) (ABTS) assays and 3,5-dinitrosalicylic acid (DNS) assays respectively. Results from the ABTS assay and DNS assay on the 4 batches are shown in FIG. 2a and FIG. 2b respectively. In both studies, a 40 ml solution of 600 mg fruit peel waste powder in DI water were used at 90° C. for 24 hours. The studies were done in triplicate and data are presented as mean±standard deviation.

It was noted that the fruit peel waste powder solution contained antioxidants equivalent to at least 0.3 mM Trolox. Furthermore, the same solution was shown to contain reducing sugars equivalent to at least 7 g/L glucose. The amount of both antioxidants and reducing sugars in all batches are also comparable thus the leaching performance of the four batches of the waste fruit peel powder should be similarly comparable.

### Example 4

### Assessing the Leaching Properties of Fruit Peel Waste Powder

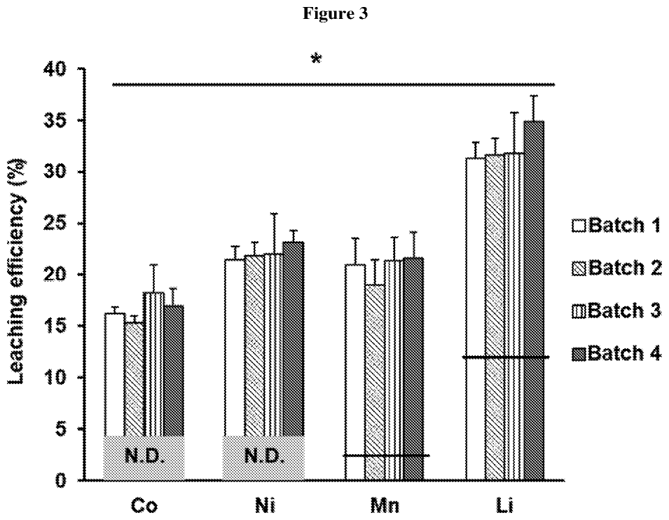

The quantity of active reducing constituents and the leaching efficiency was assessed and compared between batches of fruit peel waste to observe possible variance. To that end, the four batches of fruit peel waste powder were first tested on the NMC black mass without any added acid, with the results being shown in FIG. 3. The study was conducted with 200 mg NMC black mass, 600 mg fruit peel waste powder, and 40 ml DI water at 90° C. for 24 h. The study was done in triplicate and data are presented as mean±standard deviation. Horizontal lines indicate the leaching efficiency of Mn and Li in the control, and N.D. denotes no Co or Ni leachate was detected. * denotes significant difference between the sample group and the control group, with p<0.05.

Leaching efficiency of the different metals were quantified by Inductively coupled plasma-Optical emission spectrometry (ICP-OES). Aqua regia was used for normalization.

The leaching efficiency may be calculated using equation 1 below:

$$Equation 1$$

$$Leaching efficiency ( \% ) = \frac{[ Co , Li , Mn , Ni in sample ]}{[ Co , Li , Mn , Ni in aqua regia ]} \times 1 \; 00 \%$$

While results show that fruit peel waste alone was somewhat able to leach the metals from the black mass, the amount is generally very low and inefficient (15% for Co to 35% for Li).

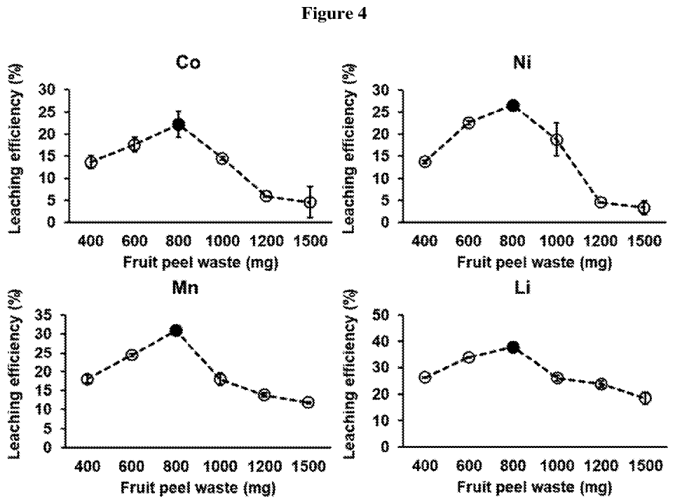

The effect of waste fruit peel powder concentration was also tested by varying the amount of fruit peel waste powder from 400 mg to 1500 mg, while maintaining the amount of black mass at 200 mg, DI water at 40 ml and at a temperature of 90° C. for 24 h, with results being shown in FIG. 4. The study was done in triplicate and data are presented as mean ±standard deviation.

Generally, an increase of leaching efficiency was observed when the amount of fruit peel waste was increased. Maximum leaching efficiency was observed at 800 mg of fruit peel waste powder indicated by a black circle in FIG. 4, after which further addition of the fruit peel waste powder led to a sharp decline in leaching efficiency across all metals. It is important to note that the leaching efficiency here is still extremely low (Co: 22.2%, Ni: 26.6%, Mn: 31.1%, Li: 38.1%).

From the postulated redox equation 2 occurring in the leaching process, it is hypothesised that the lack of H⁺ and anions to balance the cations formed may be the main cause for the sub-optimal result.

LiNiₓMn_{y}Co_{z}O₂(s)+reducing sugars+antioxidants+H⁺→Co²⁺+Mn²⁺+Li⁺+H₂O+byproducts Equation 2

### Example 5

### Confirming Leaching Properties of Fruit Peel Waste Powder with Ammonium Salts

Due to its low cost, acidity and eco-friendliness, ammonium chloride (NH₄Cl) was sourced as a possible proton donor. NH₄Cl dissolves in water to form Cl⁻ and NH₄⁺ (a source of H⁺) as shown in equations 3 and 4. However the concentration of H⁺ is largely limited by the low dissociation rate of the NH₄⁺ into H₃O⁺ (Ka=5.6×10⁻¹⁰). Preliminary experiments also reveal that the pH of a 15 wt % NH₄Cl solution is unchanged as compared to pure DI water. The low acidity of DI water comes from the natural solution of CO₂ from the ambient environment

NH₄Cl₍ₛ₎→NH₄⁺(aq)+Cl⁻(aq) Equation 3

NH₄⁺(aq)+H₂O(I) [symbol] NH₃(aq)+H₃O⁺(aq) Equation 4

Beyond its role as a proton donor, it was further postulated that the ammonium salt, in forming ammonia, assists in converting the cellulose to active reducing sugar.

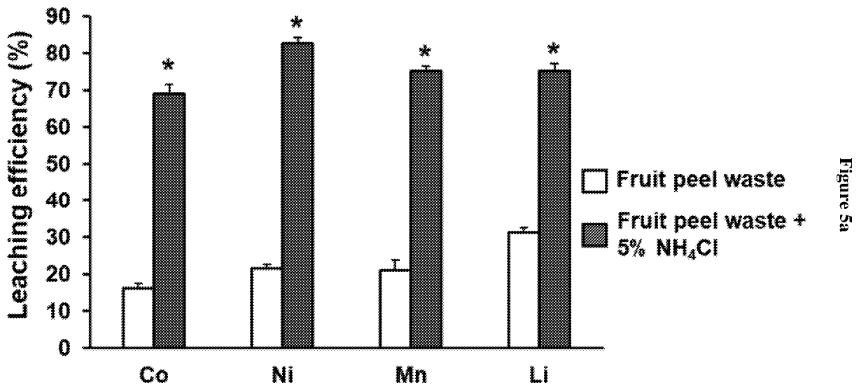

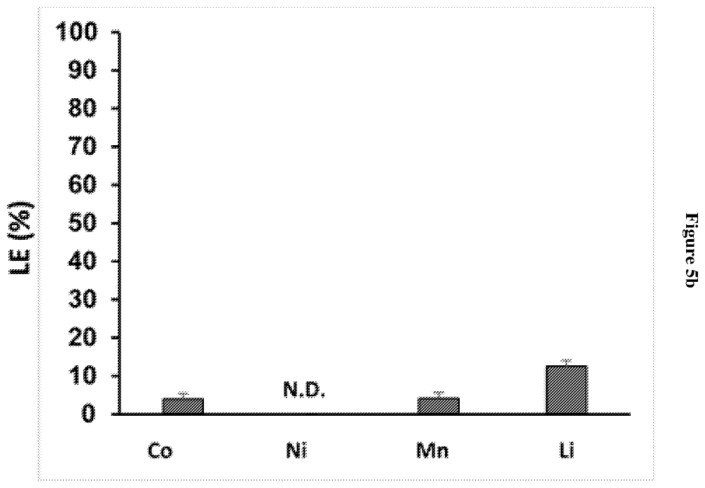

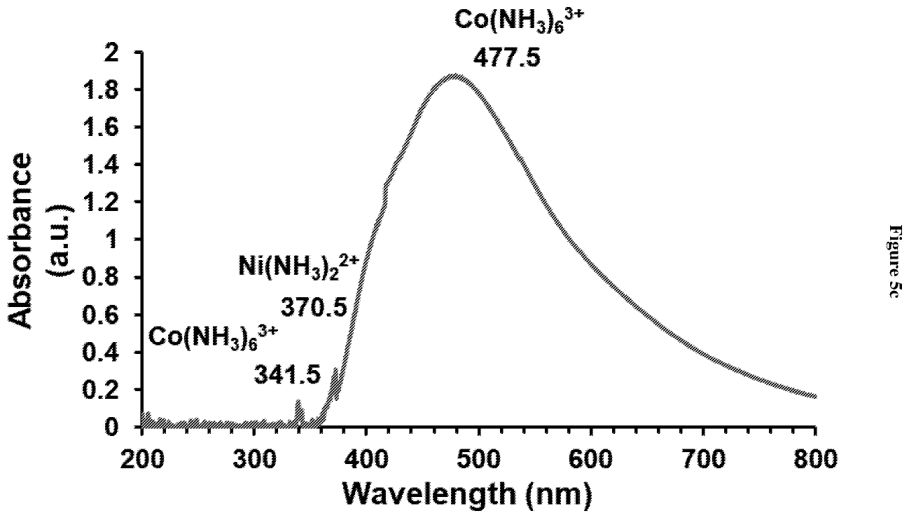

Therefore, to examine whether NH₄Cl can improve the leaching efficiency of the metals, the leaching experiments were then conducted using fruit peel waste with or without the presence of 5 wt % NH₄Cl, with the results shown in FIG. 5a. The studies were conducted using 200 mg NMC black mass, 800 mg fruit peel waste, 5 wt % NH₄Cl, and 40 ml DI water at 90° C. for 24 h. Experiments were done in triplicate, and data are presented as mean±standard deviation. * denotes significant difference between the sample group and the control group, with p<0.05.

Results show that the leaching efficiency increased by more than 100% for all metals in the presence of NH₄Cl, from about 15-35% in the absence of NH₄Cl to about 70-85% in the presence of NH₄Cl. Particularly, in the presence of NH₄Cl, 69% of Co, 82% of Ni, 75% of Mn and 75% of Li were leached out under the experimental conditions. The advantage of NH₄Cl in promoting the leaching efficiency was even more surprising, since NH₄Cl is conventionally considered as a weak acid. Conventional leaching methods have also used either strong inorganic acids, or relatively strong organic acids that depress pH of the leaching solution. This also lends credence to our earlier postulation, that both proton donors and anions are important to enhancing the reducing potential of fruit peel waste in the reductive leaching of NMC black mass.

A negative control was conducted with 5 wt % NH₄Cl and without waste fruit peel powder. Results show that just NH₄Cl was unable to leach any of the tested metals from black mass, as shown in FIG. 5b. Ni was not detected at all, while Li was the highest leached at about 12% leaching efficiency. Thus combination of waste fruit peel powder and NH₄ salts as a leaching solution is highly unprecedented and advantageous.

### Example 6

### Optimizing Ammonium Salts

From the earlier results, it was further postulated that the contribution from the anion may not be limited to simply Cl⁻ but may be extended to all other anions. Thus a further study was performed using other ammonium salts.

Six other ammonium salts were selected in place of NH₄Cl and their leaching performance were evaluated under the same conditions as used for the NH₄Cl. The pH of the leaching solution before and after were additionally taken. pH values of the respective salts used are shown in Table 1.

TABLE 1
pH of the ammonium salts before and after the leaching experiment

| Ammonium | pH before | |
|---|---|---|
| salts | leaching | pH after leaching |
| NH₄F | 6.70 | 7.50 |
| NH₄VO₃ | 6.85 | 8.90 |
| NH₄H₂PO₄ | 4.55 | 7.60 |
| (NH₄)₂SO₄ | 5.50 | 7.40 |
| (NH₄)₂S₂O₈ | 1.42 | 1.55 |
| NH₄Cl | 6.25 | 7.05 |
| NH₄CH₃COO | 7.00 | 7.30 |

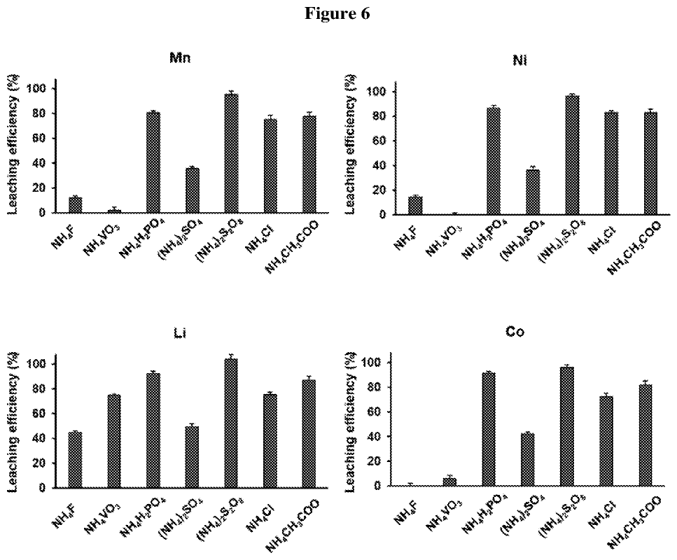

Generally, an increase in the pH was observed for all salts after leaching. This is likely due to the consumption of H⁺ during the leaching process. Leaching efficiency of the different salts are further shown in FIG. 6. In the study, 200 mg NMC black mass, 800 mg fruit peel waste powder, 5 wt % ammonium salt, and 40 ml DI water was used and the reaction run at 90° C. for 24 h. The study was performed in triplicate and data is presented as mean±standard deviation.

Results from FIG. 6 indicate that the leaching efficiency in increased in the presence of almost all ammonium salts, with the exception being NH₄F and NH₄VO₃. The low efficiency in these two cases can be accounted by the incompatibility between the metals and anions, more specifically between the Mn, Ni, Li and Co metals and the F⁻ and VO₃⁻ anions. Also, the highest leaching efficiencies were observed for (NH₄)₂S₂O₈, followed by NH₄H₂PO₄ and (NH₄)₂SO₄, which correlates with the acidity of these salts. Surprisingly, a reversal of the trend was observed for salts in the pH range of about 6 to about 7. Although NH₄Cl and NH₄CH₃COO are less acidic than (NH₄)₂SO₄, they appear to be more efficient in metal leaching. The presence of such metal-ammonia complexes can be confirmed by their respective absorption peaks on the UV-VIS spectrum, as shown in FIG. 5c. The inset shows the pH of the solution before and after leaching. From FIG. 5c, absorption peaks relating to Co(NH₃)₆³⁺, Ni(NH₃)₂²⁺ and Co(NH₃)₆³⁺ can be observed on the UV-VIS spectrum, further confirming the formation of such metal-ammonia complexes.

This enhanced leaching process could be explained by the formation of a coordination complex between the transition metal and the aqueous NH₃ molecules. An exemplary reaction that illustrates the coordination is shown in Equation 5.

M²⁺+nNH₃ [symbol] M(NH₃)ₙ²⁺ Equation 5

The effect of NH₃ consumption during the leaching process appears to have multiple effects. Firstly, consumption of NH₃ results in the formation of more H₃O⁺ in the equilibrium in Equation 4. Therefore the complexation could serve as an additional H₃O⁺ ions and account for the superior leaching performance seen in NH₄Cl and NH₄CH₃COO. Conversely, a comparatively more acidic (NH₄)₂SO₄ solution would have less unprotonated NH₃ molecules in solution and thus the succeeding complexation would be lower.

### Example 7

### Optimising Leaching Parameters

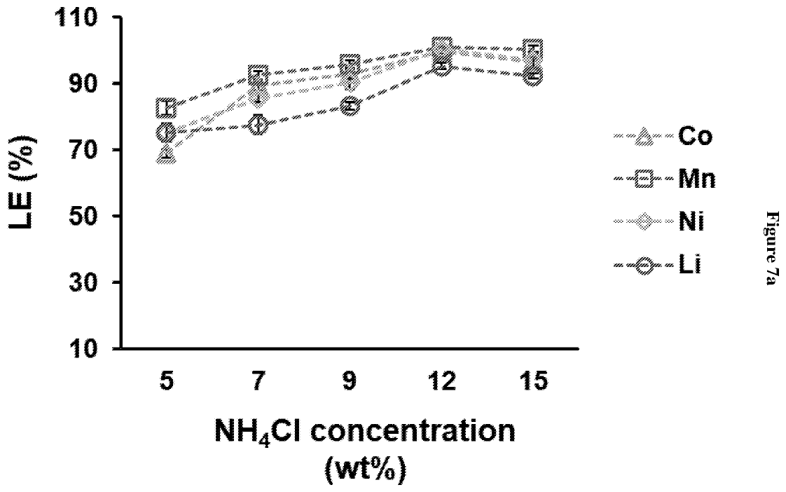

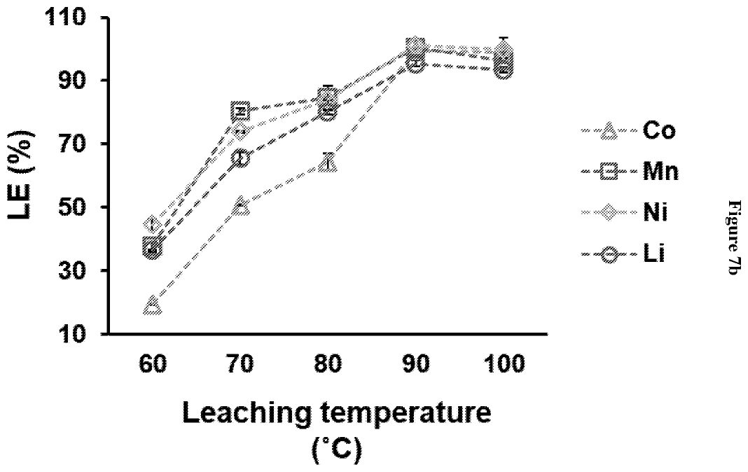

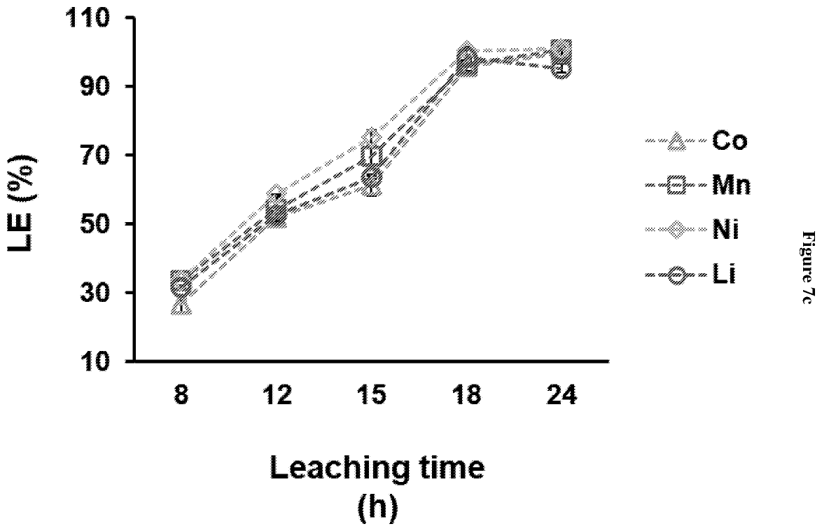

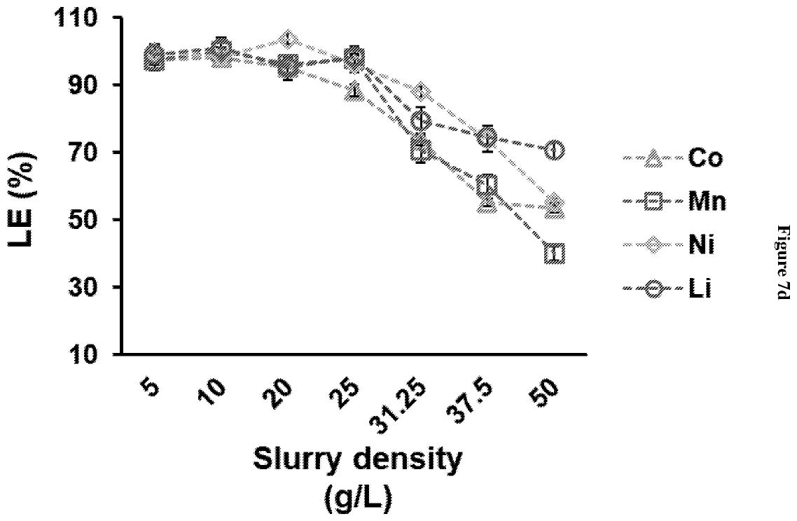

The leaching process was further optimised, with the results shown in FIGS. 7a to 7d.

The effect of ammonium salt concentration was studied and the result shown in FIG. 7a. The study was conducted with 200 mg NMC black mass, 800 mg fruit peel waste, 40 ml DI water and 5 wt % to 15 wt % of ammonium salt at a temperature of 90° C. for 24 h. NH₄Cl was used as the exemplary ammonium salt in the study. Data are presented as mean ±standard deviation.

From the results, it can be seen that there is an increase in leaching efficiency across all metals when the concentration of the salt was increased from 5 wt % to 12 wt %. The optimal concentration of ammonium salt accordingly appears to be 12 wt %, with the leaching efficiency (99.6%, 100%, 100%, 95.8% for Co, Mn, Ni, Li, respectively) decreasing slightly as the NH₄Cl concentration was increased to 15 wt % (96.4%, 100%, 97.0%, 92.2% for Co, Mn, Ni, Li, respectively).

Further, the effect of temperature was studied and the results shown in FIG. 7b. The study was conducted with 200 mg NMC black mass, 800 mg fruit peel waste powder, 40 ml DI water and 12 wt % NH₄Cl at temperatures from 60° C. to 100° C. for 24 h. Data are presented as mean±standard deviation.

From the results it can be seen that there is an increase in leaching efficiency as the temperature of the reaction is raised from 60° C. to 90° C. Maximum leaching efficiency was obtained at 90° C., and the leaching efficiency appears to remain constant or decreases only slightly when the temperature was further raised to 100° C.

Next, the effect of leaching duration was studied and the results shown in FIG. 7c. The study was conducted with 200 mg NMC black mass, 800 mg fruit peel waste powder, 40 ml DI water and 12 wt % NH₄Cl at a temperature of 90° C., from 8 h to 24 h. Data are presented as mean±standard deviation.

From the results as shown in FIG. 7c, it can be seen that there is a general increase in leaching efficiency as the duration of leaching is increased from 8 h to 18 h. Additionally, there was an additional slightly increase in leaching efficiency as the duration was further increased from 18 h to 24 h, with the exception being Li which experienced a marginal decrease in leaching efficiency as the leaching duration was raised from 18 h to 24 h.

Lastly, the effect of slurry density was studied and the results shown in FIG. 7d. The study was conducted with NMC black mass concentration from 5 g/L to 50 g/L (equivalent to 0.2 g to 2 g), 800 mg fruit peel waste powder, 40 ml DI water, 12 wt % NH₄Cl at a temperature of 90° C. for 24 h. Data are presented as mean±standard deviation.

From FIG. 7d, it can be seen that the leaching efficiency remained roughly constant as the slurry density was increased from 5 g/L to 25 g/L, with the only exception being Co decreasing to 88.4% at a slurry density of 25 g/L. Subsequently, the leaching efficiency decreases when the slurry density is increased from 25 g/L to 50 g/L suggesting that the maximum leaching efficiency appears to be at 20 g/L of NMC black mass (equivalent to 0.8 g of NMC black mass).

### Example 8

### Regeneration of Cathode Material

To further prove the industrial applicability of this present invention, NMC 111 cathode material was regenerated from the recovered ions during the leaching process.

FIG. 8a shows the general process for regenerating the cathode material. In short, ammonium oxalate was added to the leachate comprising Co, Ni, Mn and Li ions to form a leachate with CoC₂O₄(s), MnC₂O₄(s) and NiC₂O₄(s) precipitates. The precipitates were filtered off, the pH was adjusted to around 11-12 and ammonium carbonate was added to the leachate to produce a leachate and Li₂CO₃(s) precipitate. The precipitates were all combined and further metals salts added to adjust the atomic ratio of the mixture. Finally the combined mixture was annealed initially at 700° C. for 5 h, then 900° C. for 2 h to provide the regenerated NMC 111 cathode material.

To confirm the formation of the cathode material, Scanning Electron Microscopy (SEM) images of both the metal oxalate precipitate and the resultant regenerated NMC 111 cathode material were taken. SEM suggests the formation of new cathode material, which is different in morphological appearance compared to the original regenerated metal precipitates.

Additionally, X-ray Diffraction (XRD) was performed on the regenerated NMC 111 cathode material and the results compared to commercial NMC 111 cathode material, with results shown in FIG. 8d. From FIG. 8c, representative peaks at 003, 101, 006/012, 104, 015, 107, 018/110 and 113 can be seen in the regenerated cathode material, confirming the presence of the key metal ions in the regenerated NMC 111 cathode material.

The atomic composition of the crude precipitate mixture was confirmed using Energy Dispersive X-ray spectroscopy (EDX), with results being shown in FIG. 7d. Inset describes the atomic composition of the regenerated cathode material. Results indicate that the ratio of the metal ions are acceptable, with Mn:Li:Co:Ni roughly in the ratio 1:3:1:1.

### Example 9

### Cycling Performance of Regenerated Cathode Material

To confirm the electrochemical properties of the regenerated NMC 111 cathode material, a cell was assembled using the regenerated NMC 111 cathode material as the cathode. The recycled materials were mixed with carbon super P and PVDF binder (HSV900, Akema) with a weight ratio of 8:1:1 in N-methy-2pyrrolidone (NMP, Sigma-Aldrich) solvent to form homogenous slurry. The slurry was coated on Al foil (for NMC material) and dried at 80° C. overnight. The obtained electrode coatings were roll-pressed and punched out to circular piece with a diameter of 1.6 cm. Coin cells were assembled in Argon-filled glovebox, using material coating as working electrode and lithium foil as counter electrode (for half-cell assembly). The electrolyte was 1M LiPF6 in ethyl carbonate (EC), dimethyl carbonate (DMC) (1:1 volume ratio), while Cellgard 2400 membrane was used as separator. The initial discharge performance of the regenerated NMC 111 over 50 charge/discharge cycles was tested, with results shown in FIG. 8e. At a normalized charging current of 100 mA/g, it can be seen that the discharge capacity remained stabled at about 170 mAh/g even after 50 cycles, showing that the regenerated cathode material is highly stable and still possess good discharge capacity, relative to the commercial NMC 111 cathode material.

The cycling performance of the regenerated cathode material was further tested at different currents from 50 mA/g to 400 mA/g, with results shown in FIG. 8f. Similarly a commercial NMC 111 cathode was characterised under the same setting as comparison. Results showed that the discharging capacity remained constant and stable at different charging currents, showing that the cathode material regenerated from the leachate is still highly capable of use as cathode material.

### Example 10

### Recovery and Cycling Performance of Regenerated Anode Material

We further tested whether we could regenerate the graphitic based anodes from the post-leaching residue. Graphite anode was recovered directly from leaching residue. After the leaching reaction, the residue was washed with water and dried in oven at 80° C., ball-milled and underwent carbonization under N₂ atmosphere at 750° C.

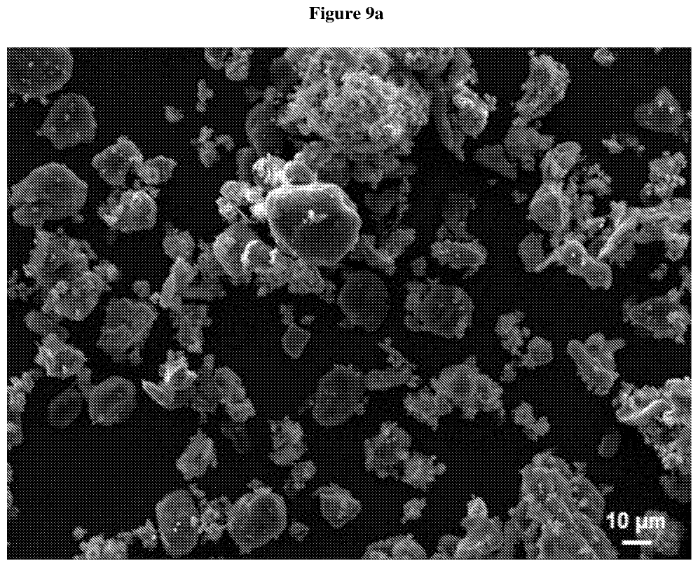

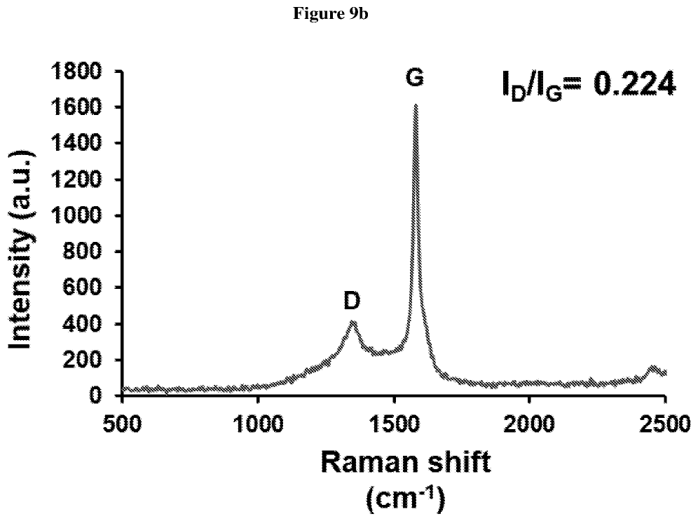

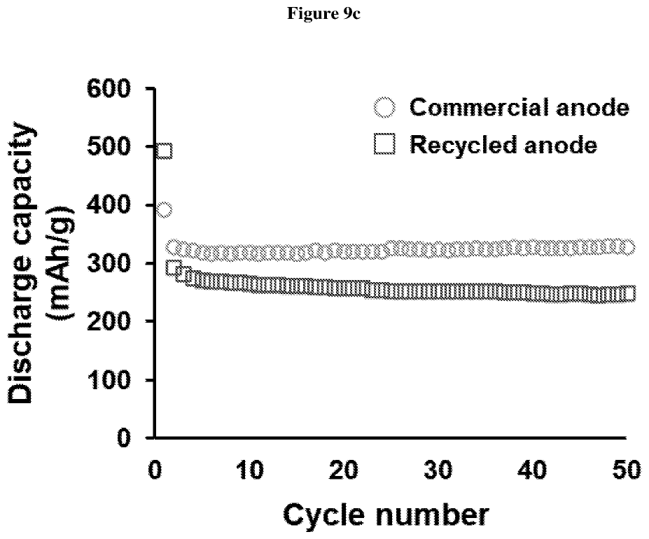

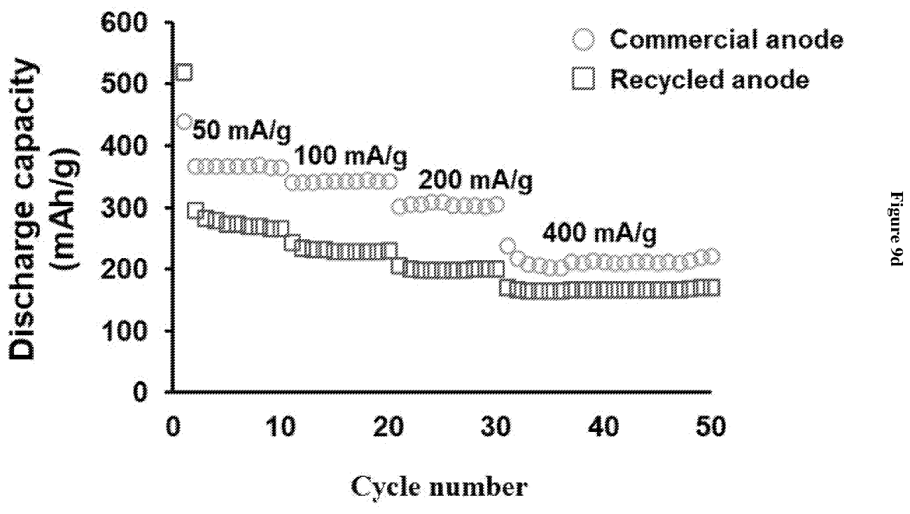

The regeneration of the anode material was confirmed by SEM images and Raman spectroscopy, as shown in FIGS. 9a and 9b. FIG. 9a shows the regenerated anode material having the correct composition and physical features, comparable to that of commercial graphitic anode material. Furthermore, the Raman spectroscopy performed on the regenerated anode material (FIG. 9b) showed a ratio of 0.224 between the disordered and graphitic carbon in the regenerated anode, which suggests the majority of recovered anode materials is graphite. The fact that graphite accounts for >80% of the recovered materials is a strong indicator of good electrochemical performance of the recovered anodes.

To confirm the cycling performance of the regenerated anode material, a cell was assembled using the anode material. The recycled materials were mixed with carbon super P and PVDF binder (HSV900, Akema) with a weight ratio of 8:1:1 in N-methy-2pyrrolidone (NMP, Sigma-A) solvent to form homogenous slurry. The slurry was coated on Cu foil (for graphite material) and dried at 80° C. overnight. The obtained electrode coatings were roll-pressed and punched out to circular piece with a diameter of 1.6 cm. Coin cells were assembled in Argon-filled glovebox, using material coating as working electrode and lithium foil as counter electrode. The electrolyte was 1M LiPF₆ in ethyl carbonate (EC), dimethyl carbonate (DMC) (1:1 volume ratio), while Cellgard 2400 membrane was used as separator.

The cycling performance of the regenerated anode material was tested at 100 mA/g, with results shown in FIG. 9c. Results showed that the discharge capacity of the anode material remained constant even after 50 cycles. Additionally, the discharge capacity after 50 cycles was about 250 mAh/g, which is comparable to the discharge capacity of the commercial anode material at about 320 mAh/g.

We additionally tested the cycling performance of the regenerated anode material at different charging currents from 20 mA/g to 400 mA/g, using commercial anode material as reference. Results are shown in FIG. 9d. From FIG. 9d, it can be seen that the discharge capacity of the regenerated anode material was comparable at all charging currents to the commercial anode material (180 mAh/g for the regenerated anode material vs 210 mAh/g for the commercial anode material), and remained stable after multiple charge/discharge cycles. This demonstrates that the leaching process of the present invention is also capable of producing cathode and anode material, with performance comparable to that of commercial cathode and anode material.

### Example 11

### Recovery and Cycling Performance of Regenerated NMC Batteries

To further test the regenerated cathode and anode material, a NMC 111 battery was assembled using the regenerated material and tested. To that end, the recovered materials were mixed with carbon super P and PVDF binder with a weight ratio of 8:1:1 in N-methy-2pyrrolidone (NMP, Sigma-Aldrich) solvent to form homogenous slurry. The slurry was coated on Al foil (for NMC material) and Cu foil (for graphite material) and dried at 80° C. overnight. The obtained electrode coatings were roll-pressed and punched out to circular piece with a diameter of 1.6 cm. Coin cells were assembled in Argon-filled glovebox, using the recovered NMC as cathode and the recovered graphite as anode. The electrolyte was 1 M LiPF₆ in ethyl carbonate (EC), dimethyl carbonate (DMC) (1:1 v/v), while Cellgard 2400 membrane was used as separator.

The discharge capacity of the NMC battery comprising the regenerated material was first tested at 100 mA/g charging current. As shown in FIG. 9a, the discharge capacity of the assembled cell remained stable over 50 discharge cycles, decreasing only slightly from 115 mAh/g to 90 mAh/g. This shows that the leaching process of the present invention is capable of producing working cathode and anode material that are still capable of producing a high discharge capacity.

### INDUSTRIAL APPLICABILITY

The present invention relates to a method of ion recovery from batteries. To do so, it uses waste fruit peel as a reductant and ammonium salts as a proton donor as well as a promoter to aid in leaching. By consuming waste fruit peels instead of conventional reductants, the method of this present invention is advantageously green and helps to alleviate land pollution. Furthermore, by using ammonium salts in place of organic or strong mineral acids, the use of bases post-leaching is greatly reduced. This further increases the safety of the leaching process, as well as reducing the amount of reagents needed, and reducing the amount of side products formed in the leaching process. This advantageously results in cost savings.

Further, as the method disclosed herein may be performed in near-neutral conditions, the disclosed method may be a non-corrosive method, unlike conventional acid-leaching methods which cause corrosion of metallic equipment (such as reactors and tubes). Therefore, the present method advantageously avoids the wear and tear of equipment that is associated with acid-leaching methods, which greatly reduces the cost of equipment maintenance.

The present disclosure also relates to a method of recovering metal salts from a battery. The method disclosed also possesses the advantageous as mentioned earlier, being greener by using waste fruit peels instead of commercial reagents as a reductant, as well as using significantly less resources to basify and precipitate out the desired metal salts from the leachate. This similarly reduces land pollution, as well as reducing the costs required to recover metal salts from batteries.

Additionally, the present disclosure also discloses a regenerated battery, formed from the metal ions recovered by the process as disclosed. This method is similarly environmentally friendly, cost effective and can be further applied to regenerate any batteries that the method is applied to.

The originality of this invention is addressing two types of waste simultaneously, which is an unprecedented step towards zero-waste society.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A method of obtaining metal ions from a battery, the method comprising adding a crushed battery to a leaching solution comprising fruit and an ammonium salt, thereby obtaining a leachate comprising metal ions.

2. The method of claim 1, wherein the ammonium salt is selected from a group comprising ammonium chloride, ammonium fluoride, ammonium iodide, ammonium bromide, ammonium vanadate, ammonium dihydrogen phosphate, ammonium hydrogen phosphate, ammonium phosphate, ammonium sulphate, ammonium hydrogen sulphate, ammonium persulfate, ammonium acetate, ammonium propionate, ammonium oxalate, ammonium carbonate, ammonium bicarbonate, ammonium thiocyanate and ammonium formate.

3. The method of claim 1, wherein the ammonium salt is dissolved in water, thereby forming NH₃ and H₃O⁺, and wherein the NH₃ forms coordination complexes with metal ions.

4. The method of claim 3, wherein the complexation between NH₃ and metal ions increases the formation rate of H₃O⁺.

5. The method of claim 1, wherein the method is performed at a pH in the range of about 5 to about 7.

6. The method of claim 1, wherein the ammonium salt is dissolved in water, wherein the weight ratio of ammonium salt to water is about 1:100 to about 1:1.

7. The method of claim 1, wherein the fruit is selected from the group comprising orange, pear, lemon, apple, banana, lime, pineapple, grapefruit, blackberry, raspberry, cranberry, tamarind, grape, mango, papaya, honeydew, pomelo, watermelon, kiwi, plum, peach, lime, sweet potato, avocado, cucumber, dragon fruit, guava, jackfruit, durian, and mixtures thereof, and wherein the fruit comprises its peel, flesh and/or seeds.

8. The method of claim 1, wherein the fruit is primarily fruit peel.

9. The method of claim 1, wherein the fruit is in powder or blended form.

10. The method of claim 9, wherein the average particle size of the fruit powder is in the range of about 50 μm to about 500 μm.

11. The method of claim 1, wherein the concentration of fruit in leaching solution is about 1 mg/mL to about 200 mg/mL.

12. The method of claim 1, wherein the metal ions comprise lithium, nickel, manganese, cobalt, zinc, copper, iron, silver, vanadium, titanium, chromium, and/or aluminium ions.

13. The method of claim 1, wherein the density of the crushed battery in the leaching solution (w_{battery}/vₛₒₗᵤₜᵢₒₙ) is from about 1 g/L to about 100 g/L.

14. The method of claim 1, wherein the method is performed at a temperature of about 40° C. to about 120° C.

15. A method of obtaining a metal salt from a battery, the method comprising:
(a) adding a crushed battery to a leaching solution comprising fruit and an ammonium salt, thereby obtaining a leachate comprising metal ions; and
(b) adding a precipitating agent to the leachate to obtain a precipitate comprising the metal salt.

16. The method of claim 15, wherein the precipitating agent is selected from the group consisting of sodium hydroxide, sodium chloride, sodium bisulfate, monosodium phosphate, disodium phosphate, trisodium phosphate, sodium carbonate, sodium bicarbonate, sodium sulfite, sodium bisulfite, calcium hydroxide, sodium oxalate, ammonium oxalate, ammonium hydroxide, ammonium bisulfate, ammonium phosphate, ammonium carbonate, ammonium bicarbonate, ammonium sulfite, oxalic acid, phosphoric acid, carbonic acid, magnesium hydroxide and any mixture thereof.

17. The method of claim 15, wherein the precipitate comprises cobalt salt, manganese salt and/or nickel salt.

18. A method of recovering and regenerating a lithium cathode material from a lithium-ion battery (LIB), the method comprising:
(a) adding a crushed LIB to a leaching solution comprising fruit and an ammonium salt, thereby obtaining a leachate comprising metal ions;
(b) adding a precipitating agent to the leachate of step (a), thereby obtaining a precipitate comprising metal salt; and
(c) mixing the precipitate of step (b) with a lithium salt and heating the resulting mixture to obtain a lithium cathode material.

19. The method of claim 18, wherein the lithium salt is selected from the group consisting of lithium hydroxide, lithium carbonate, lithium nitrate, lithium acetate, lithium oxalate, lithium chloride, lithium phosphate, lithium sulfate, lithium borate, lithium oxide, and any mixture thereof.

20. The method of claim 18, wherein the lithium cathode material is selected from the group consisting of lithium cobalt oxide (LCO), lithium manganese oxide (LMO), lithium nickel manganese cobalt oxide (LNMCO), lithium titanium oxide (LTO), lithium iron phosphate (LFP), lithium nickel oxide (LiNiO₂), lithium manganese dioxide (LiMnO₂), lithium manganese nickel oxide (LiNi_{0.5}Mn_{1.5}O₄) (LMNO), lithium manganese phosphate (LiMnPO₄), lithium nickel phosphate (LiNiPO₄), lithium cobalt phosphate (LiCoPO₄), lithium nickel cobalt aluminium oxide (LiNi_{0.8}Co_{0.15}Al_{0.05}O₂), and any mixture thereof.
